(19) United States
(12) Patent Application Publication
(10) Pub. No.: US 2016/0004034 A1
(43) Pub. Date: Jan. 7, 2016

(54) IMAGING LENS AND IMAGING APPARATUS PROVIDED WITH THE SAME

(71) Applicant: FUJIFILM Corporation, Tokyo (JP)

(72) Inventors: SUMIHIRO NISHIHATA, SAITAMA (JP); MICHIO CHO, SAITAMA (JP)

(21) Appl. No.: 14/850,927

(22) Filed: Sep. 10, 2015

Related U.S. Application Data
(63) Continuation of application No. PCT/JP2013/007604, filed on Dec. 26, 2013.

(30) Foreign Application Priority Data
Mar. 29, 2013 (JP) 2013-072283

(51) Int. Cl. G02B 9/60

(52) U.S. Cl. CPC G02B 9/60

(57) ABSTRACT

An imaging lens consists of five lenses consisting of, in order from the object side, a first lens having a positive refractive power and having a shape with a convex surface toward the object side, a second lens having a biconcave shape, a third lens having a biconvex shape, a fourth lens having a positive refractive power, and a fifth lens having a negative refractive power, having a shape with a concave surface toward the image side, and having at least one inflection point on the image-side surface thereof. The imaging lens satisfies a given condition expression.

### CROSS-REFERENCE TO RELATED APPLICATIONS

This application is a Continuation of PCT International Application No. PCT/JP2013/007604 filed on Dec. 26, 2013, which claims priority under 35 U.S.C. §119(a) to Japanese Patent Application No. 2013-072283 filed on Mar. 29, 2013. Each of the above applications is hereby expressly incorporated by reference, in its entirety, into the present application.

### TECHNICAL FIELD

The present disclosure relates to a fixed-focus imaging lens that forms an optical image of a subject on an image sensor, such as a CCD (Charge Coupled Device) or CMOS (Complementary Metal Oxide Semiconductor), and an imaging apparatus that is provided with the imaging lens and performs imaging, such as a digital still camera, a mobile phone with camera, a personal digital assistance (PDA), a smartphone, a tablet-type terminal, a portable video game player, etc.

### BACKGROUND ART

Along with the spread of personal computers in ordinary homes, etc., digital still cameras that are capable of inputting image information, such as photographed landscapes and portraits, to a personal computer are also rapidly spreading. Further, more and more mobile phones, smartphones, and tablet-type terminals are equipped with a camera module for inputting images. The above-mentioned devices capable of imaging use an image sensor, such as a CCD or CMOS. In recent years, such image sensors are becoming more and more compact, and there are demands for compact imaging apparatuses and compact imaging lenses to be mounted on the imaging apparatuses. At the same time, pixel density of such image sensors is also becoming higher, and imaging lenses with higher resolution and higher performance are demanded. For example, performance that can accommodate a high pixel density of 5 megapixel or more, or more preferably 8 megapixel or more is demanded.

In order to meet the above-described demands, providing an imaging lens formed by a relatively large number of lenses, namely, having a five or six-lens configuration may be considered. For example, each of Japanese Unexamined Patent Publication No. 2012-189894 and U.S. Patent Application Publication No. 20120087019 (hereinafter, Patent Documents 1 and 2) proposes an imaging lens with a five-lens configuration including, in order from the object side, a first lens having a positive refractive power, a second lens having a negative refractive power, a third lens having a positive refractive power, a fourth lens having a positive refractive power, and a fifth lens having a negative refractive power.

### SUMMARY

On the other hand, for an imaging lens for use, in particular, with devices that are becoming thinner and thinner, such as PDAs, smartphones and tablet-type terminals, there are increasing demands for reduction of the entire length of the lens and achieving wider angle of view of the lens. However, the imaging lens of Patent Document 1 has not achieved sufficient reduction of the entire length, and the imaging lens of Patent Document 2 has narrow angle of view.

In view of the above-described circumstances, the present disclosure is directed to providing an imaging lens that is capable of achieving high imaging performance throughout from the central angle of view to the peripheral angle of view while achieving reduction of the entire length and wide angle of view, and an imaging apparatus provided with the imaging lens and capable of obtaining high-resolution images.

An imaging lens of the disclosure consists of five lenses consisting of, in order from the object side:

a first lens having a positive refractive power and having a shape with a convex surface toward the object side;

a second lens having a biconcave shape;

a third lens having a biconvex shape;

a fourth lens having a positive refractive power; and

a fifth lens having a negative refractive power, having a shape with a concave surface toward the image side, and having at least one inflection point on the image-side surface thereof,

wherein the condition expression (1) below is satisfied:

0.13<d45/f1234<0.3 (1),

where d45 is a distance between the fourth lens and the fifth lens along the optical axis, and f1234 is a combined focal length of the first to the fourth lenses.

According to the imaging lens of the disclosure, which has the five-lens configuration as a whole, the configuration of each lens element of the first to the fifth lenses is optimized to accomplish a lens system having high resolution performance while achieving a wide angle of view and reducing the entire length.

It should be noted that, with respect to the imaging lens of the disclosure, the expression “consisting of five lenses” means that the imaging lens of the disclosure may include, in addition to the five lenses: lenses substantially without any power; optical elements other than lenses, such as a stop and a cover glass; mechanical components, such as a lens flange, a lens barrel, an image sensor, and a camera shake correcting mechanism; etc. It should be noted that the sign (positive or negative) with respect to the surface shape and the refractive power of any lens having an aspheric surface of the above-described lenses is about the paraxial region.

When the imaging lens of the disclosure further employs and satisfies the following preferred features, even higher optical performance can be achieved.

It is preferred that the imaging lens of the disclosure further include an aperture stop disposed on the object side of the object-side surface of the second lens.

It is preferred that the imaging lens of the disclosure satisfy any of the conditional expressions (1-1) to (9-1) below. In preferred aspects of the disclosure, any one or any combination of the conditional expressions (1-1) to (9-1) may be satisfied. It should be noted that, in the condition expressions (3) and (3-1), |R2f|>|R2r|.

0.14<d45/f1234<0.25 (1-1),

0.11<d45/f<0.3 (2),

0.11<d45/f<0.25 (2-1),

0<(R2f+R2r)/(R2f−R2r)<0.5 (3),

0.1<(R2f+R2r)/(R2f−R2r)<0.35 (3-1),

−1<(R5f+R5r)/(R5f−R5r)<0.08 (4),

−0.5<(R5f+R5r)/(R5f−R5r)<0.07 (4-1),

0.5<f·tan ω/R5r<10 (5),

0.7<f·tan ω/R5r<3 (5-1),

0.7<f/f12<1.2 (6),

0.8<f/f12<1 (6-1),

0.8<f/f1<2.5 (7),

1<f/f1<2 (7-1),

−2.5<f/f5<−1.2 (8),

−2<f/f5<−1.4 (8-1),

−2.5<f/f2<−0.7 (9),

−1.3<f/f2<−0.8 (9-1),

where f is a focal length of the entire system,
f1 is a focal length of the first lens,
f2 is a focal length of the second lens,
f5 is a focal length of the fifth lens,
f12 is a combined focal length of the first lens and the second lens,
f1234 is a combined focal length of the first to the fourth lenses,
R2f is a paraxial radius of curvature of the object-side surface of the second lens,
R2r is a paraxial radius of curvature of the image-side surface of the second lens,
R5f is a paraxial radius of curvature of the object-side surface of the fifth lens,
R5r is a paraxial radius of curvature of the image-side surface of the fifth lens, and
ω is a half angle of view.

An imaging apparatus according to the disclosure comprises the imaging lens of the disclosure.

The imaging apparatus according to the disclosure allows obtaining a high resolution image signal based on a high resolution optical image that is obtained with the imaging lens of the disclosure.

According to the imaging lens of the disclosure, which has the five-lens configuration as a whole, the configuration of the lens elements, in particular, the shapes of the first and the fifth lenses are optimized to accomplish a lens system having a wide angle of view and having high imaging performance throughout from the central angle of view to the peripheral angle of view while reducing the entire length.

Further, the imaging apparatus of the disclosure outputs an imaging signal according to an optical image that is formed by the imaging lens with high imaging performance of the disclosure, and therefore allows obtaining high-resolution images.

### BRIEF DESCRIPTION OF THE DRAWINGS

FIG. 1 is a lens sectional view illustrating a first configuration example of an imaging lens according to one embodiment of the disclosure and corresponding to Example 1,

FIG. 2 is a lens sectional view illustrating a second configuration example of the imaging lens according to one embodiment of the disclosure and corresponding to Example 2,

FIG. 3 is a lens sectional view illustrating a third configuration example of the imaging lens according to one embodiment of the disclosure and corresponding to Example 3,

FIG. 4 is a lens sectional view illustrating a fourth configuration example of the imaging lens according to one embodiment of the disclosure and corresponding to Example 4,

FIG. 5 is a lens sectional view illustrating a fifth configuration example of the imaging lens according to one embodiment of the disclosure and corresponding to Example 5,

FIG. 6 is a lens sectional view illustrating a sixth configuration example of the imaging lens according to one embodiment of the disclosure and corresponding to Example 6,

FIG. 7 is a diagram showing optical paths through the imaging lens shown in FIG. 2,

FIG. 8 shows aberration diagrams of the imaging lens according to Example 1 of the disclosure, where spherical aberration is shown at A, astigmatism (field curvature) is shown at B, distortion is shown at C, and lateral chromatic aberration is shown at D,

FIG. 9 shows aberration diagrams of the imaging lens according to Example 2 of the disclosure, where spherical aberration is shown at A, astigmatism (field curvature) is shown at B, distortion is shown at C, and lateral chromatic aberration is shown at D,

FIG. 10 shows aberration diagrams of the imaging lens according to Example 3 of the disclosure, where spherical aberration is shown at A, astigmatism (field curvature) is shown at B, distortion is shown at C, and lateral chromatic aberration is shown at D,

FIG. 11 shows aberration diagrams of the imaging lens according to Example 4 of the disclosure, where spherical aberration is shown at A, astigmatism (field curvature) is shown at B, distortion is shown at C, and lateral chromatic aberration is shown at D,

FIG. 12 shows aberration diagrams of the imaging lens according to Example 5 of the disclosure, where spherical aberration is shown at A, astigmatism (field curvature) is shown at B, distortion is shown at C, and lateral chromatic aberration is shown at D,

FIG. 13 shows aberration diagrams of the imaging lens according to Example 6 of the disclosure, where spherical aberration is shown at A, astigmatism (field curvature) is shown at B, distortion is shown at C, and lateral chromatic aberration is shown at D,

FIG. 14 shows an imaging apparatus in the form of a mobile phone terminal provided with the imaging lens according to the disclosure, and

FIG. 15 shows an imaging apparatus in the form of a smartphone provided with the imaging lens according to the disclosure.

### DESCRIPTION OF EMBODIMENTS

Hereinafter, embodiments of the present disclosure will be described in detail with reference to the drawings.

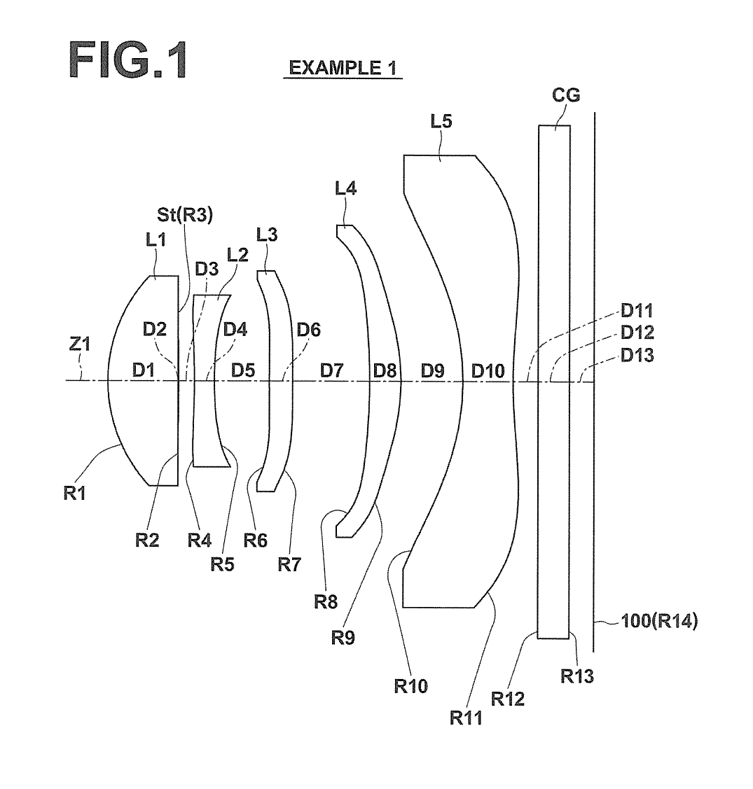

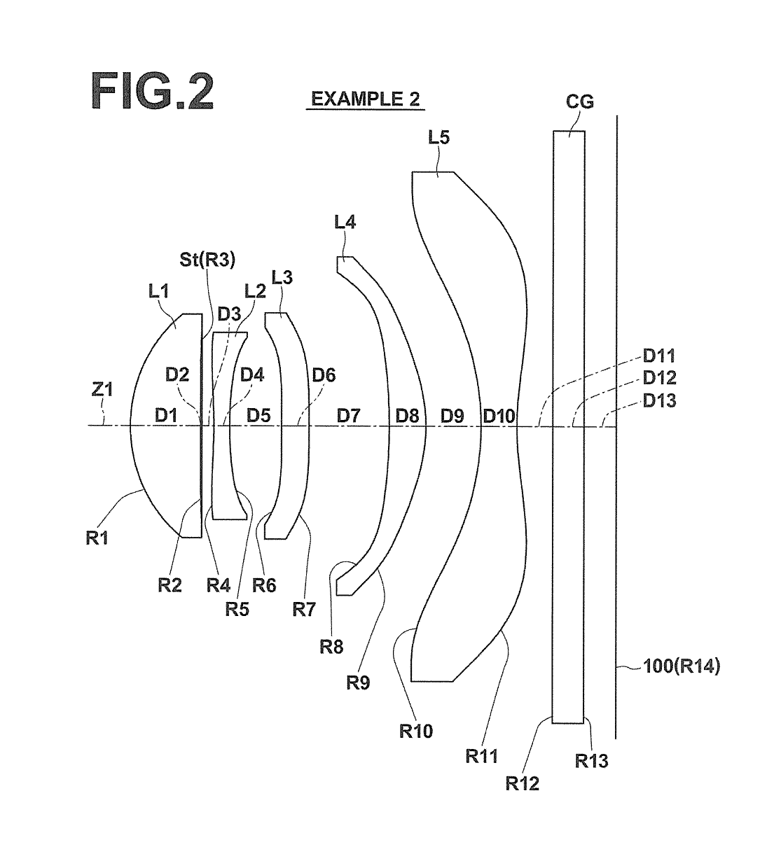

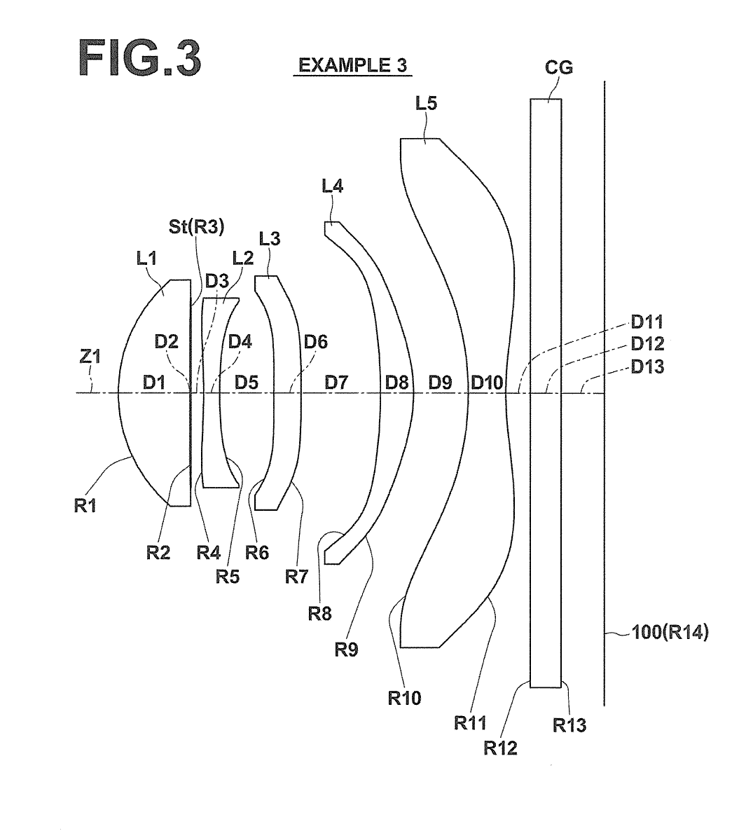

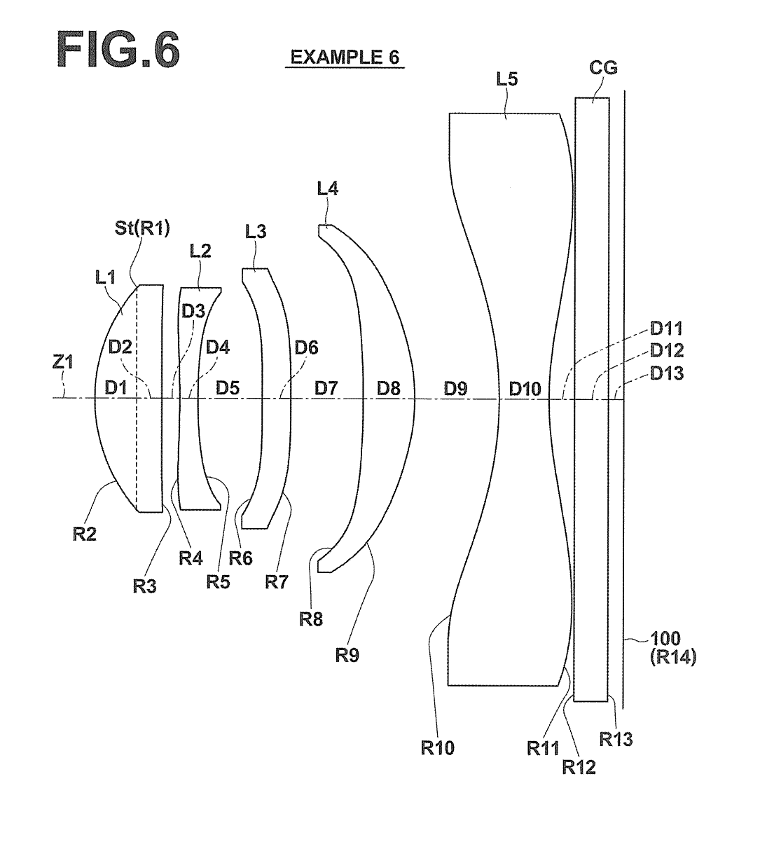

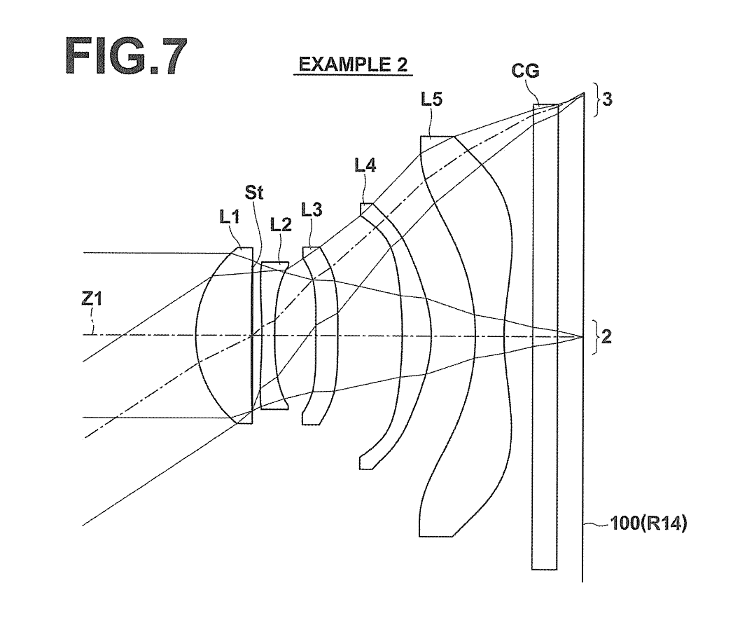

FIG. 1 shows a first configuration example of an imaging lens according to a first embodiment of the disclosure. This configuration example corresponds to the lens configuration of a first numerical example (shown in Tables 1 and 2), which will be described later. Similarly, FIGS. 2 to 6 show cross-sectional configurations of second to sixth configuration examples corresponding to the lens configurations of numerical examples (Tables 3 to 12) according to second to sixth embodiments, which will be described later. In FIGS. 1 to 6, each symbol “Ri” denotes a radius of curvature of the i-th surface, where the most object-side surface of the lens elements is the first surface and the surface number is sequentially increased toward the image side (the formed image side), and each symbol “Di” denotes a surface distance between the i-th surface and the i+1-th surface along the optical axis Z1. It should be noted that these configuration examples have the same basic configuration. Therefore the following description is made based on the configuration example of the imaging lens shown in FIG. 1, and the configuration examples shown in FIGS. 2 to 6 are described as necessary. FIG. 7 is a diagram showing optical paths through the imaging lens L according to the second embodiment shown in FIG. 2, and shows optical paths of an axial bundle of rays 2 and a bundle of rays 3 at the maximum angle of view from an object point at infinity.

The imaging lens L according to each embodiment of the disclosure is preferably usable with various imaging apparatuses using an image sensor, such as a CCD or CMOS, in particular, relatively small portable terminal devices, such as digital still cameras, mobile phones with camera, smartphones, tablet-type terminals and PDAs. The imaging lens L includes, in order from the object side along the optical axis Z1, a first lens L1, a second lens L2, a third lens L3, a fourth lens L4, and a fifth lens L5.

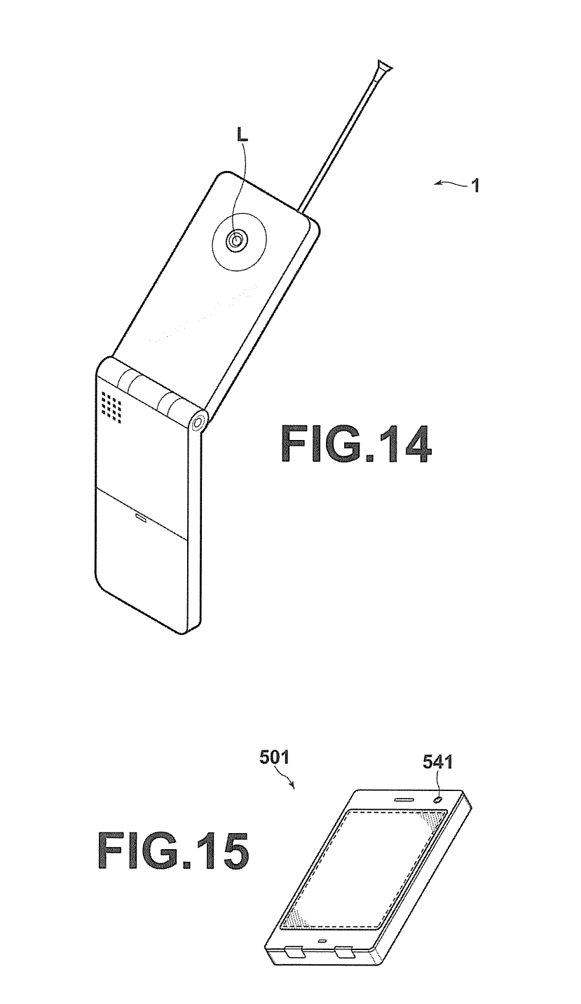

FIG. 14 shows the appearance of a mobile phone terminal which is an imaging apparatus 1 according to one embodiment of the disclosure. The imaging apparatus 1 of the embodiment of the disclosure includes the imaging lens L of an embodiment of the disclosure, and an image sensor 100 (see FIG. 1), such as a CCD, which outputs an imaging signal according to an optical image formed by the imaging lens L. The image sensor 100 is placed in the image plane (image plane R14) of the imaging lens L.

FIG. 15 shows the appearance of a smartphone which is an imaging apparatus 501 according to one embodiment of the disclosure. The imaging apparatus 501 of the embodiment of the disclosure includes a camera unit 541 which includes the imaging lens L of an embodiment of the disclosure and an image sensor 100 (see FIG. 1), such as a CCD, which outputs an imaging signal according to an optical image formed by the imaging lens L. The image sensor 100 is placed in the image plane (imaging surface) of the imaging lens L.

Various types of optical member CG may be provided between the fifth lens L5 and the image sensor 100 depending on the configuration of the camera on which the lens is mounted. For example, a cover glass for protecting the imaging surface, and a flat plate-like optical member, such as an infrared cut-off filter, may be provided between the fifth lens L5 and the image sensor 100. In this case, for example, a flat plate-like cover glass with a coating having a filter effect, such as an effect of an infrared cut-off filter or ND filter, or a material having the same effect may be used as the optical member CG

Alternatively, without using any optical member CG, the fifth lens L5 may be provided with a coating having the same effect as the optical member CG, for example. This allows reducing the number of parts forming the lens and reducing the entire length of the lens.

It is preferred that the imaging lens L include an aperture stop St disposed on the object side of the object-side surface of the second lens L2. Disposing the aperture stop St on the object side of the object-side surface of the second lens L2 in this manner allows suppressing increase of the incidence angle of rays traveling through the optical system onto the image plane (the image sensor), in particular, at the periphery of the imaging area. In order to enhance the above-described advantageous effect, it is preferred that the aperture stop St be disposed on the object side of the object-side surface of the first lens L1. It should be noted that the description “disposed on the object side of the object-side surface of the second lens” means that the position of the aperture stop St along the optical axis direction is the same position as the intersection between the axial marginal ray and the object-side surface of the second lens L2 or a position nearer to the object side than the intersection. Similarly, the description “disposed on the object side of the object-side surface of the first lens” means that the position of the aperture stop St along the optical axis direction is the same position as the intersection between the axial marginal ray and the object-side surface of the first lens L1 or a position nearer to the object side than the intersection.

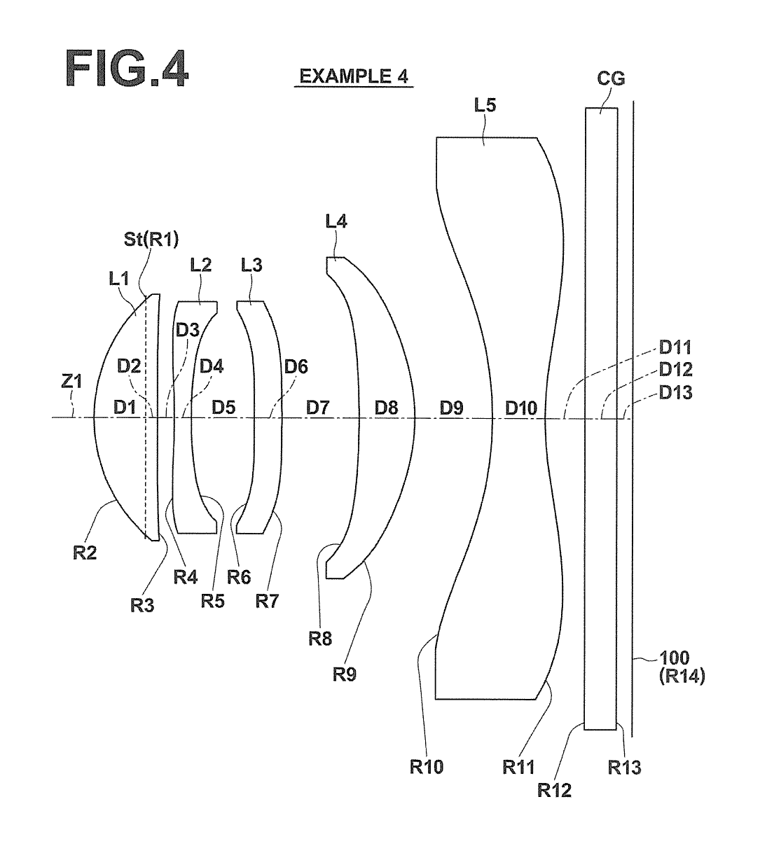

In this embodiment, the lenses of the fourth to the sixth configuration examples (FIGS. 4 to 6) are configuration examples where the aperture stop St is disposed on the object side of the object-side surface of the first lens L1, and the lenses of the first to the third configuration examples (FIGS. 1 to 3) are configuration examples where the aperture stop St is disposed on the object side of the object-side surface of the second lens L2. It should be noted that the aperture stop St shown in each drawing does not necessarily represent the size and the shape of the aperture stop St, but represents the position of the aperture stop St along the optical axis Z1.

In the case where the aperture stop St is disposed on the object side of the object-side surface of the first lens L1 along the optical axis direction, it is preferred that the aperture stop St be disposed on the image side of the apex of the surface of the first lens L1. When the aperture stop St is disposed on the image side of the apex of the surface of the first lens L1 in this manner, reduction of the entire length of the imaging lens L including the aperture stop St can be achieved. Further, while the aperture stop St is disposed on the image side of the apex of the surface of the first lens L1 in this embodiment, this is not intended to limit the invention, and the aperture stop St may be disposed at the apex of the surface of the first lens L1, or disposed on the object side of the apex of the surface of the first lens L1. Disposing the aperture stop St on the object side of the apex of the surface of the first lens L1 is somewhat disadvantageous in view of ensuring peripheral brightness than disposing the aperture stop St on the image side of the apex of the surface of the first lens L1. However, this preferably allows further suppressing increase of the incidence angle of rays traveling through the optical system onto the image plane (the image sensor) at the periphery of the imaging area.

Alternatively, the aperture stop St may be disposed between the first lens L1 and the second lens L2 along the optical axis direction, as with the imaging lens L according to each of the first to the third embodiments shown in FIGS. 1 to 3. This allows successfully correcting field curvature. Disposing the aperture stop St between the first lens L1 and the second lens L2 along the optical axis direction is disadvantageous in view of ensuring telecentricity, that is, making the principal ray parallel to the optical axis as much as possible (making the incidence angle on the imaging surface near to zero), than disposing the aperture stop St on the object side of the object-side surface of the first lens L1 along the optical axis direction. However, preferable optical performance can be achieved when an image sensor with reduced degradation of light reception efficiency and reduced color mixing due to increase of the incidence angle when compared to those of conventional image sensors, which has recently been accomplished along with the development of the image sensor technique, is applied.

In the imaging lens L, the first lens L1 has a positive refractive power in the vicinity of the optical axis, and has a shape with a convex surface toward the object side in the vicinity of the optical axis. Providing the first lens L1, which is the most object-side lens, having a positive refractive power and having a shape with a convex surface toward the object side in the vicinity of the optical axis allows preferably reducing the entire length. Further, in the case where the first lens L1 has a biconvex shape, as shown in the first embodiment and the third to the sixth embodiments, reduction of the entire length can preferably be achieved while successfully correcting spherical aberration. In the case where the first lens L1 has a meniscus shape with the convex surface toward the object side, as shown in the fourth and the fifth embodiments, it is easier to make the position of the rear principal point of the first lens L1 closer to the object side, and this allows preferably reducing the entire length.

The second lens L2 has a biconcave shape in the vicinity of the optical axis. This allows preferably reducing the entire length while successfully correcting axial chromatic aberration and spherical aberration.

The third lens L3 has a biconvex shape in the vicinity of the optical axis. This allows preferably reducing the entire length while successfully correcting spherical aberration.

The fourth lens L4 has a positive refractive power in the vicinity of the optical axis. This allows preferably reducing the entire length. The fourth lens L4 may have a meniscus shape with the concave surface toward the object side. This allows preferably correcting astigmatism.

The fifth lens L5 has a negative refractive power in the vicinity of the optical axis, and has a shape with a concave surface toward the image side in the vicinity of the optical axis. Disposing the lens having a negative refractive power in the vicinity of the optical axis at the most image-side position of the imaging lens allows more preferably achieving a telephoto configuration of the imaging lens as a whole, and preferably reducing the entire length. Further, the fifth lens L5 having a negative refractive power in the vicinity of the optical axis allows preferably correcting field curvature. Further, the fifth lens L5 having a shape with a concave surface toward the image side in the vicinity of the optical axis allows successfully correcting field curvature while more preferably achieving reduction of the entire length. In order to enhance the above-described advantageous effects, it is preferred that the fifth lens L5 have a biconcave shape in the vicinity of the optical axis, as shown in each embodiment.

The fifth lens L5 has at least one inflection point within the effective diameter of the image-side surface. The “inflection point” of the image-side surface of the fifth lens L5 refers to a point where the shape of the image-side surface of the fifth lens L5 changes from a convex shape toward the image side to a concave shape toward the image side (or from a concave shape toward the image side to a convex shape toward the image side). The position of the inflection point can be any position within an effective diameter of the image-side surface of the fifth lens L5 along the radial direction from the optical axis. The image-side surface of the fifth lens L5 having a shape with at least one inflection point, as shown in each embodiment, allows suppressing increase of the incidence angle of rays traveling through the optical system onto the imaging surface (image sensor), in particular, at the peripheral area of the imaging area.

According to the above-described imaging lens L, which has the five-lens configuration as a whole, the configuration of each lens element of the first to the fifth lenses L1 to L5 is optimized to accomplish a lens system having wide angle of view and having high resolution performance while reducing the entire length.

In order to achieve even higher performance, it is preferred that each of the first to the fifth lenses L1 to L5 of the imaging lens L has an aspheric surface on at least one side thereof.

Further, it is preferred that each of the lenses L1 to L5 forming the imaging lens L be a single lens rather than a cemented lens. In this case, the number of aspheric surfaces is greater than that in a case where any of the lenses L1 to L5 are cemented together to form a cemented lens. This allows higher freedom of design of each lens to preferably reduce the entire length of the lens.

Next, operation and effects related to conditional expressions of the imaging lens L having the above-described configuration are described in more detail.

First, it is preferred that a distance d45 between the fourth lens L4 and the fifth lens L5 along the optical axis, and a combined focal length f1234 of the first to the fourth lenses L1 to L4 satisfy the condition expression (1) below:

0.13<d45/f1234<0.3 (1).

The condition expression (1) defines a preferred numerical range of the ratio of the distance d45 between the fourth lens L4 and the fifth lens L5 along the optical axis relative to the combined focal length f1234 of the first to the fourth lenses L1 to L4 for correcting field curvature to achieve wide angle of view while reducing the entire length by reducing the back focus and balancing the thicknesses of the first to the fifth lenses L1 to L5. In this embodiment, since the fifth lens L5 has a negative refractive power, the combined refractive power of the first to the fourth lenses L1 to L4 is necessarily positive. Therefore, setting the distance d45 between the fourth lens L4 and the fifth lens L5 along the optical axis relative to the combined focal length f1234 of the first to the fourth lenses L1 to L4 such that the lower limit of the condition expression (1) is satisfied allows making the principal point position closer to the object side, and this allows reducing the back focus to preferably reduce the entire length. This also allows reducing the Petzval sum, thereby allowing successfully correcting field curvature and achieving wide angle of view. Setting the distance d45 between the fourth lens L4 and the fifth lens L5 along the optical axis relative to the combined focal length f1234 of the first to the fourth lenses L1 to L4 such that the upper limit of the condition expression (1) is satisfied allows reducing the thicknesses of the first to the fifth lenses L1 to L5, thereby preferably reducing the entire length. In order to enhance the above-described advantageous effects, it is more preferred that the condition expression (1-1) below be satisfied, and it is even more preferred that the condition expression (1-2) below be satisfied:

0.14<d45/f1234<0.25 (1-1),

0.15<d45/f1234<0.2 (1-2).

Further, it is preferred that the distance d45 between the fourth lens L4 and the fifth lens L5 along the optical axis and a focal length f of the entire system satisfy the condition expression below (2):

0.11<d45/f<0.3 (2).

The condition expression (2) defines a preferred numerical range of the ratio of the distance d45 between the fourth lens L4 and the fifth lens L5 along the optical axis relative to the focal length f of the entire system for reducing the entire length, and correcting field curvature to achieve wide angle of view by reducing the back focus and balancing the thicknesses of the first to the fifth lenses L1 to L5, similarly to the condition expression (1). In this embodiment, since the fifth lens L5 has a negative refractive power, the combined refractive power of the first to the fourth lenses L1 to L4 is necessarily positive. Therefore, setting the distance d45 between the fourth lens L4 and the fifth lens L5 along the optical axis relative to the focal length f of the entire system such that the lower limit of the condition expression (2) is satisfied allows making the principal point position closer to the object side, and this reduces the back focus to preferably reduce the entire length. This also allows reducing the Petzval sum, thereby allowing successfully correcting field curvature and achieving wide angle of view. Setting the distance d45 between the fourth lens L4 and the fifth lens L5 along the optical axis relative to the focal length f of the entire system such that the upper limit of the condition expression (2) is satisfied allows reducing the thicknesses of the first to the fifth lenses L1 to L5, thereby preferably reducing the entire length. In order to enhance the above-described advantageous effects, it is more preferred that the condition expression (2-1) below be satisfied, and it is even more preferred that the condition expression (2-2) below be satisfied:

0.11<d45/f<0.25 (2-1),

0.12<d45/f<0.2 (2-2).

It is preferred that a paraxial radius of curvature R2f of the object-side surface of the second lens L2 and a paraxial radius of curvature R2r of the image-side surface of the second lens L2 satisfy the condition expression (3) below:

0<(R2f+R2r)/(R2f−R2r)<0.5 (3),

where |R2f|>|R2r|.

The condition expression (3) defines a preferred numerical range of the paraxial radius of curvature R2f of the object-side surface of the second lens L2 and the paraxial radius of curvature R2r of the image-side surface of the second lens L2. Setting the paraxial radius of curvature R2f of the object-side surface of the second lens L2 and the paraxial radius of curvature R2r of the image-side surface of the second lens L2 such that the lower limit of the condition expression (3) is satisfied allows preferably reducing the entire length. Setting the paraxial radius of curvature R2f of the object-side surface of the second lens L2 and the paraxial radius of curvature R2r of the image-side surface of the second lens L2 such that the upper limit of the condition expression (3) is satisfied allows successfully correcting astigmatism. In order to enhance the above-described advantageous effects, it is more preferred that the condition expression (3-1) below be satisfied, and it is even more preferred that the condition expression (3-2) below be satisfied:

0.1<(R2f+R2r)/(R2f−R2r)<0.35 (3-1),

0.11<(R2f+R2r)/(R2f−R2r)<0.3 (3-2).

It is preferred that the paraxial radius of curvature R5f of the object-side surface of the fifth lens L5 and the paraxial radius of curvature R5r of the image-side surface of the fifth lens L5 satisfy the condition expression (4) below:

−1<(R5f+R5r)/(R5f−R5r)<0.08 (4).

The condition expression (4) defines a preferred numerical range of the paraxial radius of curvature R5f of the object-side surface of the fifth lens L5 and the paraxial radius of curvature R5r of the image-side surface of the fifth lens L5. Setting the paraxial radius of curvature R5f of the object-side surface of the fifth lens L5 and the paraxial radius of curvature R5r of the image-side surface of the fifth lens L5 such that the lower limit of the condition expression (4) is satisfied allows successfully correcting astigmatism. Setting the paraxial radius of curvature R5f of the object-side surface of the fifth lens L5 and the paraxial radius of curvature R5r of the image-side surface of the fifth lens L5 such that the upper limit of the condition expression (4) is satisfied allows preferably reducing the entire length. In order to enhance the above-described advantageous effects, it is more preferred that the condition expression (4-1) below be satisfied, and it is even more preferred that the condition expression (4-2) below be satisfied:

−0.5<(R5f+R5r)/(R5f−R5r)<0.07 (4-1),

−0.4<(R5f+R5r)/(R5f−R5r)<0.06 (4-2).

Further, it is preferred that the focal length f of the entire system, a half angle of view ω, and the paraxial radius of curvature R5r of the image-side surface of the fifth lens L5 satisfy the conditional expression (5) below:

0.5<f·tan ω/R5r<10 (5).

The conditional expression (5) defines a preferred numerical range of the ratio of a paraxial image height (f·tan ω) to the paraxial radius of curvature R5r of the image-side surface of the fifth lens L5. When the paraxial image height (f·tan ω) relative to the paraxial radius of curvature R5r of the image-side surface of the fifth lens L5 is set such that the lower limit of the conditional expression (5) is satisfied, the absolute value of the paraxial radius of curvature R5r of the image-side surface of the fifth lens L5, which is the most image-side surface of the imaging lens L, does not become excessively large relative to the paraxial image height (f·tan ω), and this allows sufficiently correcting field curvature while achieving reduction of the entire length. When the paraxial image height (f·tan ω) relative to the paraxial radius of curvature R5r of the image-side surface of the fifth lens L5 is set such that the upper limit of the conditional expression (5) is satisfied, the absolute value of the paraxial radius of curvature R5r of the image-side surface of the fifth lens L5, which is the most image-side surface of the imaging lens L, does not become excessively small relative to the paraxial image height (f·tan ω), and this allows suppressing increase of the incidence angle of rays traveling through the optical system onto the image plane (the image sensor), in particular, at the intermediate angle of view. In order to enhance the above-described advantageous effects, it is preferred that the condition expression (5-1) below be satisfied:

0.7<f·tan ω/R5r<3 (5-1).

It is preferred that a combined focal length f12 of the first lens L1 and the second lens L2 and the focal length f of the entire system satisfy the condition expression (6) below:

0.7<f/f12<1.2 (6).

The condition expression (6) defines a preferred numerical range of the ratio of the focal length f of the entire system relative to the combined focal length f12 of the first lens L1 and the second lens L2. When the combined refractive power of the first lens L1 and the second lens L2 is set such that the lower limit of the condition expression (6) is satisfied, the combined refractive power of the first lens L1 and the second lens L2 does not become excessively weak relative to the refractive power of the entire system, and this preferably allows reducing the entire length. When the combined refractive power of the first lens L1 and the second lens L2 is set such that the upper limit of the condition expression (6) is satisfied, the combined refractive power of the first lens L1 and the second lens L2 does not become excessively strong relative to the refractive power of the entire system, and this allows successfully correcting, in particular, spherical aberration and axial chromatic aberration. In order to enhance the above-described advantageous effects, it is more preferred that the condition expression (6-1) below be satisfied:

0.8<f/f12<1 (6-1).

It is preferred that a focal length f1 of the first lens L1 and the focal length f of the entire system satisfy the condition expression (7) below:

0.8<f/f1<2.5 (7).

The condition expression (7) defines a preferred numerical range of the ratio of the focal length f of the entire system relative to the focal length f1 of the first lens L1. When the refractive power of the first lens L1 is set such that the lower limit of the condition expression (7) is satisfied, the positive refractive power of the first lens L1 does not become excessively weak relative to the refractive power of the entire system, and this preferably allows reduction of the entire length. When the refractive power of the first lens L1 is set such that the upper limit of the condition expression (7) is satisfied, the positive refractive power of the first lens L1 does not become excessively strong relative to the refractive power of the entire system, and this allows successfully correcting, in particular, spherical aberration. In order to enhance the above-described advantageous effects, it is more preferred that the condition expression (7-1) below be satisfied, and it is even more preferred that the condition expression (7-2) below be satisfied:

1<f/f1<2 (7-1),

1.4<f/f1<1.8 (7-2).

It is preferred that a focal length f5 of the fifth lens L5 and the focal length f of the entire system satisfy the condition expression (8) below:

−2.5<f/f5<−1.2 (8).

The condition expression (8) defines a preferred numerical range of the ratio of the focal length f of the entire system relative to the focal length f5 of the fifth lens L5. When the refractive power of the fifth lens L5 is set such that the lower limit of the condition expression (8) is satisfied, the refractive power of the fifth lens L5 does not become excessively strong relative to the positive refractive power of the entire system, and this allows suppressing increase of the incidence angle of rays traveling through the optical system onto the imaging surface (image sensor), in particular, at the intermediate angle of view. When the refractive power of the fifth lens L5 is set such that the upper limit of the condition expression (8) is satisfied, the refractive power of the fifth lens L5 does not become excessively weak relative to the refractive power of the entire system, and this allows preferably reducing the entire length while successfully correcting field curvature. In order to enhance the above-described advantageous effects, it is more preferred that the condition expression (8-1) below be satisfied:

−2<f/f5<−1.4 (8-1).

It is preferred that a focal length f2 of the second lens L2 and the focal length f of the entire system satisfy the condition expression (9) below:

−2.5<f/f2<−0.7 (9).

The condition expression (9) defines a preferred numerical range of the ratio of the focal length f of the entire system relative to the focal length f2 of the second lens L2. When the refractive power of the second lens L2 is set such that the lower limit of the condition expression (9) is satisfied, the refractive power of the second lens L2 does not become excessively strong relative to the refractive power of the entire system, and this preferably allows reduction of the entire length. When the refractive power of the second lens L2 is set such that the upper limit of the condition expression (9) is satisfied, the refractive power of the second lens L2 does not become excessively weak relative to the refractive power of the entire system, and this allows successfully correcting, in particular, axial chromatic aberration. In order to enhance the above-described advantageous effects, it is more preferred that the condition expression (9-1) below be satisfied:

−1.3<f/f2<−0.8 (9-1).

Next, the imaging lens according to each of the second to the sixth embodiments of the disclosure is described in detail with reference to FIGS. 2 to 6. In the imaging lens according to each of the first to the sixth embodiments shown in FIGS. 1 to 6, all the surfaces of the first to the fifth lenses L1 to L5 have an aspheric shape. Similarly to the imaging lens according to the first embodiment, the imaging lens according to each of the second to the sixth embodiments of the disclosure consists of five lenses consisting of, in order from the object side, a first lens L1 having a positive refractive power and having a shape with a convex surface toward the object side, a second lens L2 having a biconcave shape, a third lens L3 having a biconvex shape, a fourth lens L4 having a positive refractive power, and a fifth lens L5 having a negative refractive power, having a shape with a concave surface toward the image side, and having at least one inflection point on the image-side surface thereof. In the following description of the second to the sixth embodiments, only detailed configurations of the individual lenses other than those described above are described. Further, each feature that is common among the first to the sixth embodiments has the same operational advantage in the first to the sixth embodiments, and the configuration and the operational advantage of such a feature are described only with respect to the embodiment in which the feature first appears, and the same explanations are not repeated in description of the other embodiments.

The imaging lens L according to each of the second, the third and the sixth embodiments shown in FIGS. 2, 3 and 6 has the same features of the first to the fifth lenses L1 to L5 as those of the first embodiment, and each feature of the lenses provides the same advantageous effects as those of the corresponding feature of the first embodiment.

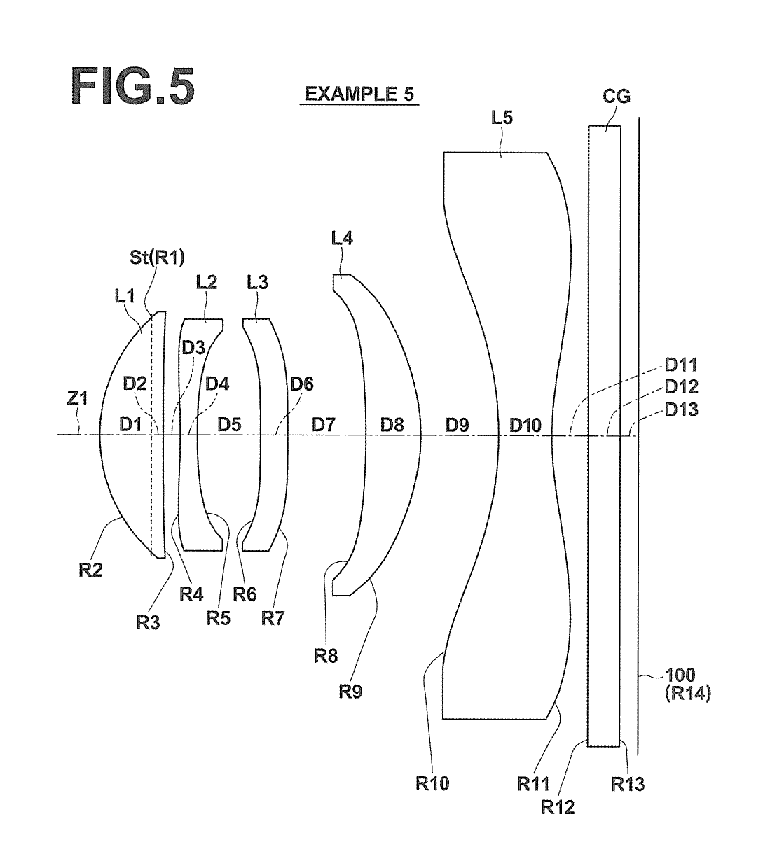

The imaging lens L according to each of the fourth and the fifth embodiments shown in FIGS. 4 and 5 has the same features of the first to the fifth lenses L1 to L5 as those of the first embodiment except that the first lens L1 has a meniscus shape with the convex surface toward the object side. The first lens L1 having a meniscus shape with the convex surface toward the object side facilitates making the rear principal point position of the first lens L1 closer to the object side, thereby preferably reducing the entire length. In the fourth and the fifth embodiments, each feature of the first to the fifth lenses L1 to L5 that is the same as that of the first embodiment provides the same advantageous effects as those of the corresponding feature of the first embodiment.

It should be noted that the imaging lens according to each of the fourth to the sixth embodiments does not satisfy the upper limit of the condition expression (1-2).

As described above, according to the imaging lens L of each embodiment of the disclosure, which has the five-lens configuration as a whole, the configuration of each lens element is optimized to accomplish a lens system having a wide angle of view and having high resolution performance while reducing the entire length.

The imaging lens according to each embodiment of the disclosure can achieve even higher imaging performance by satisfying the above-described preferred conditions, as appropriate. The imaging apparatus according to each embodiment of the disclosure outputs an imaging signal according to an optical image that is formed by the high-performance imaging lens of each embodiment of the disclosure, and therefore can capture a high-resolution image throughout from the central angle of view to the peripheral angle of view.

Next, specific numerical examples of the imaging lens according to the embodiments of the disclosure are described. In the following description, several numerical examples are explained at once.

Tables 1 and 2 presented below show specific lens data corresponding to the configuration of the imaging lens shown in FIG. 1. Specifically, Table 1 shows basic lens data, and Table 2 shows data about aspheric surfaces. Each value in the column of surface number “Si” in the lens data shown in Table 1 of the imaging lens according to Example 1 is the surface number of the i-th surface, where the most object-side surface of the lens elements is the 1st surface (the aperture stop St is the 3rd surface) and the number is sequentially increased toward the image side. Each value in the column of radius of curvature “Ri”, which corresponds to each symbol “Ri” shown in FIG. 1, is the value (mm) of radius of curvature of the i-th surface from the object side. Each value in the column of surface distance “Di” is the surface distance (mm) between the i-th surface Si and the i+1-th surface Si+1 from the object side along the optical axis. Each value in the column of “ndj” is the value of refractive index with respect to the d-line (wavelength 587.56 nm) of the j-th optical element from the object side. Each value in the column of “vdj” is the value of Abbe number with respect to the d-line of the j-th element from the object side. It should be noted that the lens data also shows values of the focal length f (mm) of the entire system, the back focus Bf (mm), and the entire lens length TL (mm). It should be noted that the value of the back focus Bf is an equivalent air distance, and a portion corresponding to the back focus in the entire lens length TL is the equivalent air distance.

Each of the first to the fifth lenses L1 to L5 of the imaging lens according to Example 1 has aspheric surfaces on both sides. The value of radius of curvature of each aspheric surface in the basic lens data shown in Table 1 is a value of radius of curvature in the vicinity of the optical axis (paraxial radius of curvature).

Table 2 shows aspheric surface data of the imaging lens of Example 1. In each value shown as the aspheric surface data, the symbol “E” means that the numerical value following the symbol “E” is an exponent with the base being 10, and that the numerical value before the symbol “E” is multiplied by the numerical value represented by the exponential function with the base being 10. For example, “1.0E-02” means “1.0×10⁻².”

As the aspheric surface data, values of coefficients Ai and KA in the formula of aspheric shape expressed as the formula (A) below are shown. More specifically, Z represents a length (mm) of a perpendicular line from a point on the aspheric surface at a height h from the optical axis to a plane (a plane perpendicular to the optical axis) tangential to the apex of the aspheric surface.

Z=C·h²/{1+(1−KA·C²·h²)^{1/2}}+ΣAi·hⁱ (A),

where Z is a depth (mm) of the aspheric surface, h is a distance (mm) from the optical axis to the lens surface (height), C is a paraxial curvature=1/R (where R is a paraxial radius of curvature), Ai is an i-th order (where i is an integer of 3 or more) aspheric coefficient, and KA is an aspheric coefficient.

Similarly to the lens data of the imaging lens of Example 1 described above, specific lens data corresponding to the configurations of imaging lenses shown in FIGS. 2 to 6 are shown as Examples 2 to 6 in Tables 3 to 12. In the imaging lenses according to Examples 1 to 6, each of the first to the fifth lenses L1 to L5 has aspheric surfaces on both sides.

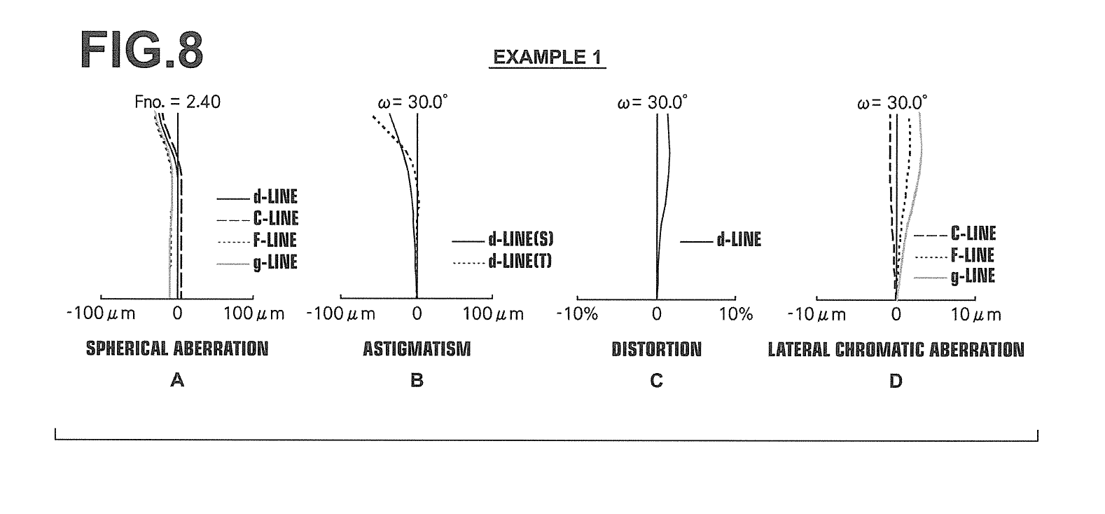

FIG. 8 shows, at A to D, aberration diagrams of spherical aberration, astigmatism, distortion, and lateral chromatic aberration (chromatic aberration of magnification), respectively, of the imaging lens of Example 1. Each aberration shown in the aberration diagrams of spherical aberration, astigmatism (field curvature), and distortion is with respect to the d-line (the wavelength of 587.56 rim) used as the reference wavelength. The aberration diagrams of spherical aberration and lateral chromatic aberration also show the aberrations with respect to the g-line (the wavelength of 435.83 nm), the F-line (the wavelength of 486.1 nm) and the C-line (the wavelength of 656.27 nm). In the aberration diagram of astigmatism, the aberration in the sagittal direction (S) is shown in the solid line and the aberration in the tangential direction (T) is shown in the dotted line. The symbol “Fno.” means “F-number” and the symbol “ω” means “half angle of view.”

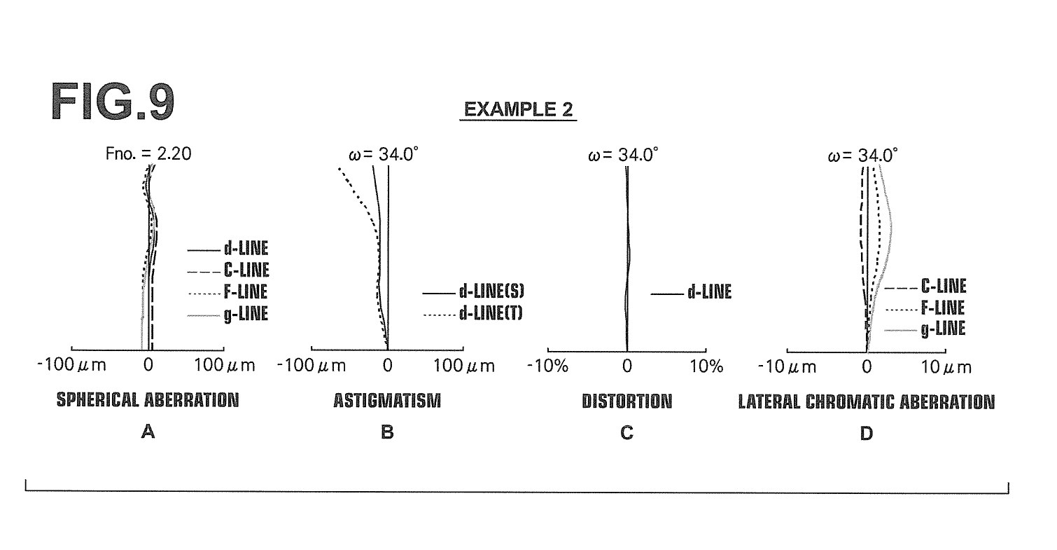

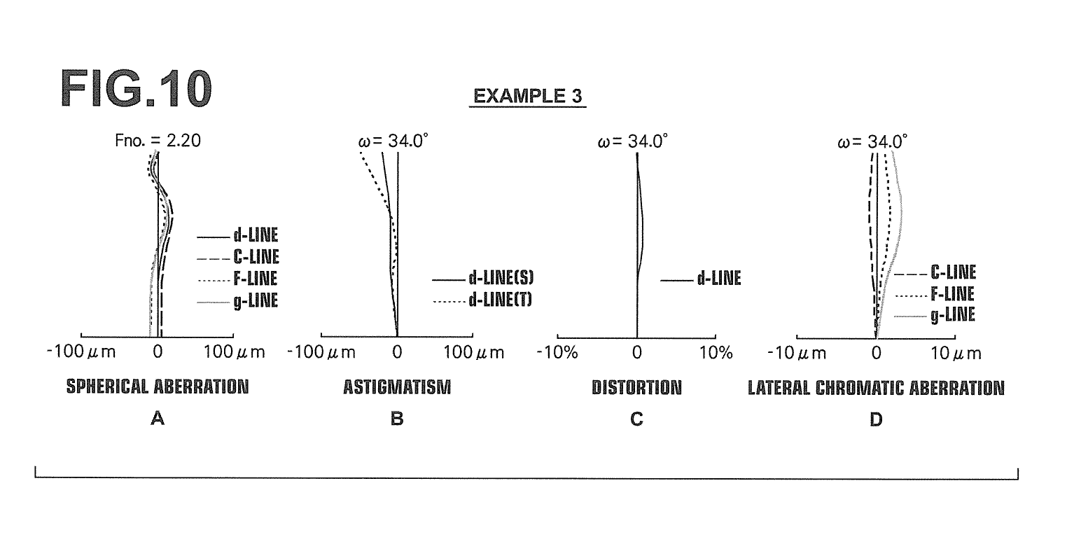

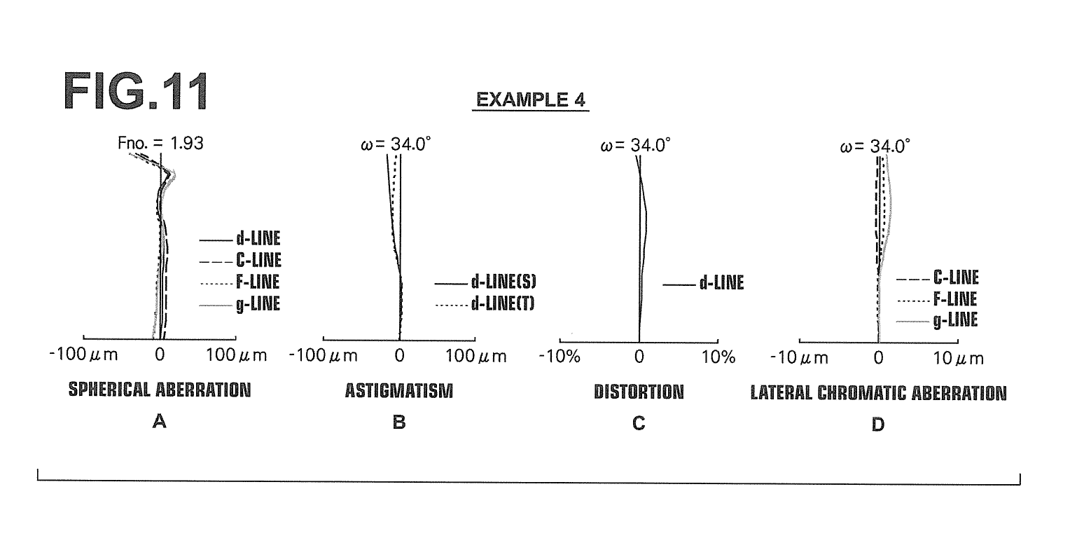

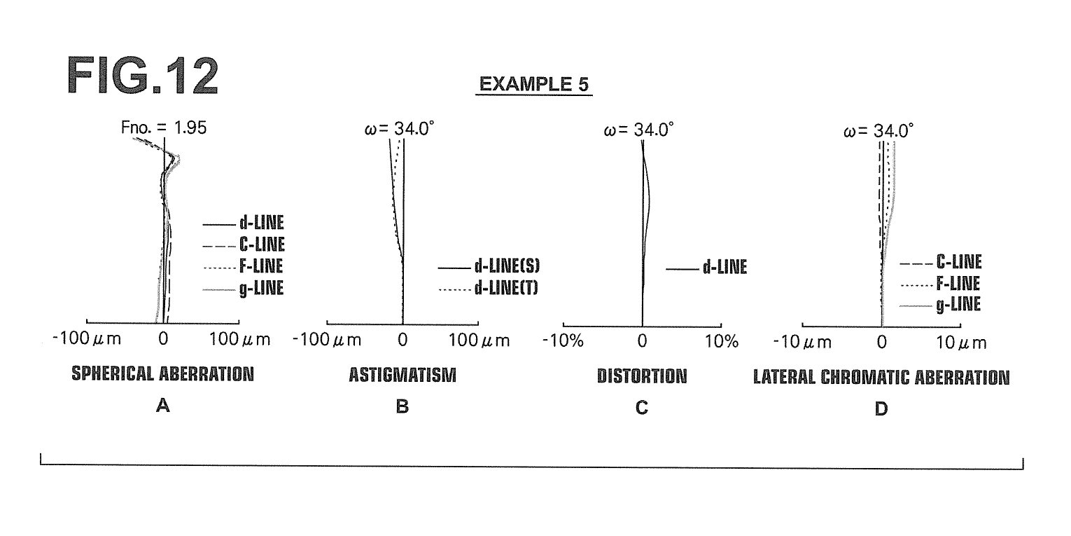

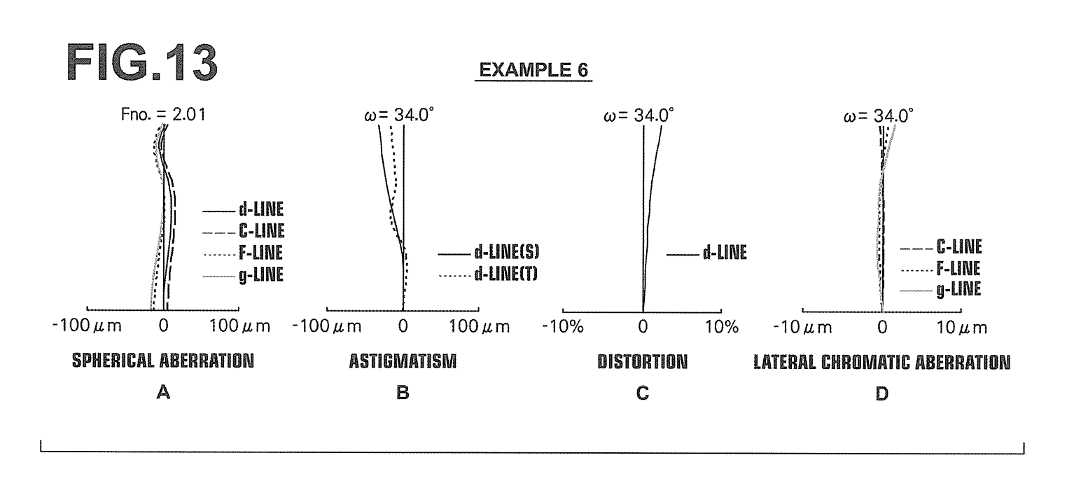

Similarly, the various aberrations of the imaging lenses of Examples 2 to 6 are shown at A to D in FIGS. 9 to 13.

Further, Table 13 shows values relating to the conditional expressions (1) to (9) according to the disclosure for each of Examples 1 to 6.

As can be seen from the numerical data and the aberration diagrams, high imaging performance is achieved while reducing the entire length in each example.

It should be noted that the imaging lens of the invention is not limited to the above-described embodiments and examples, and various medications may be made to the disclosure to carry out the invention. For example, the values of the radius of curvature, the surface distance, the refractive index, the Abbe number, the aspheric coefficients, etc., of each lens component are not limited to the values shown in the numerical examples and may take different values.

Further, while the imaging lenses of the above-described examples are described on the assumption that they are used as fixed-focus lenses, the imaging lens of the invention can be configured to allow focusing. For example, automatic focusing can be achieved by moving the entire lens system or moving part of the lenses forming the lens system along the optical axis.

TABLE 1
Example 1
f = 4.454, Bf = 0.729, TL = 4.605

| Si | Ri | Di | ndj | νdj |
|---|---|---|---|---|
| *1 | 1.45219 | 0.679 | 1.54400 | 55.90 |
| *2 | −23.32279 | 0.100 | | |
| 3 (aperture stop) | ∞ | 0.035 | | |
| *4 | −6.35596 | 0.191 | 1.63400 | 23.80 |
| *5 | 3.72001 | 0.527 | | |
| *6 | 13.67873 | 0.225 | 1.63400 | 23.80 |
| *7 | −516.11350 | 0.740 | | |
| *8 | −6.20907 | 0.302 | 1.54400 | 55.90 |
| *9 | −1.91680 | 0.594 | | |
| *10 | −2.32330 | 0.483 | 1.53500 | 56.30 |
| *11 | 4.65516 | 0.240 | | |
| 12 | ∞ | 0.300 | 1.51700 | 64.20 |
| 13 | ∞ | 0.291 | | |
| 14 | ∞ | | | |

*aspheric surface

TABLE 2
Example 1 • Aspheric Surface Data

| Surface | | | | | | | |
|---|---|---|---|---|---|---|---|
| No. | KA | A4 | A6 | A8 | A10 | A12 | A14 |
| 1 | −3.4675730E+00 | 1.7602721E−01 | −8.0376835E−02 | 5.7959266E−02 | −2.1769894E−02 | 7.6666158E−03 | −3.6517226E−03 |
| 2 | −2.1663840E+03 | 1.0203334E−02 | 1.8312484E−02 | −4.4360659E−02 | 7.9757152E−02 | −7.0202977E−02 | 2.0903657E−02 |
| 4 | −1.6564070E+02 | 5.0038760E−02 | 1.0539675E−02 | 5.0713781E−02 | −1.3359091E−01 | 1.3057064E−01 | −4.5409770E−02 |
| 5 | 1.0314825E+01 | 8.9403315E−02 | 8.8090074E−03 | 4.6927070E−02 | −7.9596805E−02 | 5.2458344E−02 | 4.2606177E−02 |
| 6 | 1.1402130E+02 | −1.7533764E−01 | −4.5933048E−02 | 5.5700082E−02 | −8.0366327E−02 | 6.6596315E−02 | |
| 7 | 1.0000000E+00 | −1.5198129E−01 | −2.3406972E−02 | 2.2457912E−02 | −2.0525518E−02 | 2.3251098E−02 | |
| 8 | 9.7008050E+00 | 5.3110771E−03 | 2.3822104E−02 | −5.3164237E−02 | 3.8010676E−02 | −2.0274155E−02 | 4.2971388E−03 |
| 9 | −4.3789110E+00 | −6.7189627E−03 | 5.3634425E−02 | −4.1580576E−02 | 8.4294093E−03 | −1.1759112E−03 | 2.7154470E−04 |
| 10 | −2.6060910E+00 | −1.5572671E−02 | −7.4984622E−04 | 2.5052165E−03 | −2.9220267E−04 | −3.4359306E−05 | 5.7063799E−06 |
| 11 | −3.1720270E+01 | −3.7255294E−02 | 6.4600091E−03 | −2.0972960E−03 | 3.2016516E−04 | −2.4548879E−05 | 1.1739173E−06 |

TABLE 3
Example 2
f = 4.454, Bf = 0.863, TL = 4.604

| Si | Ri | Di | ndj | νdj |
|---|---|---|---|---|
| *1 | 1.42915 | 0.681 | 1.54400 | 55.90 |
| *2 | −51.19692 | 0.010 | | |
| 3 (aperture stop) | ∞ | 0.115 | | |
| *4 | −5.61877 | 0.154 | 1.63400 | 23.80 |
| *5 | 4.40115 | 0.501 | | |
| *6 | 53.72163 | 0.266 | 1.63400 | 23.80 |
| *7 | −32.14791 | 0.779 | | |
| *8 | −5.14940 | 0.355 | 1.54400 | 55.90 |
| *9 | −1.50362 | 0.534 | | |
| *10 | −2.67690 | 0.346 | 1.53500 | 56.30 |
| *11 | 2.49345 | 0.351 | | |
| 12 | ∞ | 0.300 | 1.51700 | 64.20 |
| 13 | ∞ | 0.315 | | |
| 14 | ∞ | | | |

*aspheric surface

TABLE 4
Example 2 • Aspheric Surface Data

| Surface | | | | | | | |
|---|---|---|---|---|---|---|---|
| No. | KA | A4 | A6 | A8 | A10 | A12 | A14 |
| 1 | −3.2308460E+00 | 1.8247298E−01 | −7.7950683E−02 | 5.9096960E−02 | −2.1002646E−02 | 8.2367395E−03 | −2.4930025E−03 |
| 2 | −2.0381740E+04 | 1.1969677E−02 | 1.8960781E−02 | −4.4902294E−02 | 7.9876744E−02 | −6.9231624E−02 | 2.1876014E−02 |
| 4 | −1.1195360E+02 | 5.2110101E−02 | 1.3075487E−02 | 5.0711220E−02 | −1.3577418E−01 | 1.2938918E−01 | −3.9484706E−02 |
| 5 | 1.2428030E+01 | 9.8635724E−02 | 1.7519353E−02 | 4.2159066E−02 | −9.0080209E−02 | 5.4249856E−02 | 8.6341923E−02 |
| 6 | −7.1350970E+03 | −1.8622730E−01 | −4.6933694E−02 | 4.8245647E−02 | −7.9588998E−02 | 5.8291981E−02 | |
| 7 | 1.0000000E+00 | −1.5654478E−01 | −2.0899996E−02 | 2.1053205E−02 | −2.2821506E−02 | 2.3006544E−02 | |
| 8 | 9.0199420E+00 | 1.0508175E−02 | 1.5539425E−02 | −5.1621495E−02 | 3.8794521E−02 | −2.0226471E−02 | 4.2452229E−03 |
| 9 | −3.6089910E+00 | −2.3664935E−02 | 5.5243667E−02 | −4.1074818E−02 | 8.5220012E−03 | −1.1320107E−03 | 2.8762245E−04 |
| 10 | −1.0675030E+00 | −1.5650477E−02 | −5.3715853E−04 | 2.5453229E−03 | −2.8762512E−04 | −3.4236548E−05 | 5.5712130E−06 |
| 11 | −2.3095940E+01 | −4.0228964E−02 | 6.6396595E−03 | −2.0973815E−03 | 3.2109609E−04 | −2.4276932E−05 | 1.2175782E−06 |

TABLE 5
Example 3
f = 4.451, Bf = 0.853, TL = 4.603

| Si | Ri | Di | ndj | νdj |
|---|---|---|---|---|
| *1 | 1.43478 | 0.691 | 1.54400 | 55.90 |
| *2 | −57.13259 | 0.010 | | |
| 3 (aperture stop) | ∞ | 0.123 | | |
| *4 | −5.66016 | 0.154 | 1.63400 | 23.80 |
| *5 | 4.45390 | 0.525 | | |
| *6 | 40.74845 | 0.264 | 1.63400 | 23.80 |
| *7 | −38.78278 | 0.770 | | |
| *8 | −5.00824 | 0.320 | 1.54400 | 55.90 |
| *9 | −1.55119 | 0.531 | | |
| *10 | −2.76821 | 0.362 | 1.53500 | 56.30 |
| *11 | 2.76124 | 0.237 | | |
| 12 | ∞ | 0.300 | 1.51700 | 64.20 |
| 13 | ∞ | 0.418 | | |
| 14 | ∞ | | | |

*aspheric surface

TABLE 6
Example 3 • Aspheric Surface Data

| Surface | | | | | | | |
|---|---|---|---|---|---|---|---|
| No. | KA | A4 | A6 | A8 | A10 | A12 | A14 |
| 1 | −3.3199300E+00 | 1.8022776E−01 | −7.8654831E−02 | 5.9762074E−02 | −2.1236648E−02 | 7.3966372E−03 | −3.5354205E−03 |
| 2 | −2.1255220E+04 | 1.1130495E−02 | 1.7789724E−02 | −4.6314868E−02 | 7.9576648E−02 | −6.8937540E−02 | 2.1758847E−02 |
| 4 | −1.1988640E+02 | 5.1297301E−02 | 1.2089253E−02 | 5.0979463E−02 | −1.3430607E−01 | 1.3044455E−01 | −3.9279142E−02 |
| 5 | 1.2824720E+01 | 9.9288293E−02 | 1.8986037E−02 | 4.003549E−02 | −9.4591536E−02 | 4.6736735E−02 | 9.5778049E−02 |
| 6 | −3.8180170E+03 | −1.8415180E−01 | −4.8001973E−02 | 4.6099590E−02 | −8.0573804E−02 | 6.4931092E−02 | |
| 7 | 1.0000000E+00 | −1.5864911E−01 | −2.1203920E−02 | 2.1577480E−02 | −2.2065892E−02 | 2.3021357E−02 | |
| 8 | 7.9672230E+00 | 9.6129552E−03 | 1.4753402E−02 | −5.1178156E−02 | 3.8941295E−02 | −2.0188373E−02 | 4.2516087E−03 |
| 9 | −3.7754090E+00 | −2.3221255E−02 | 5.4789159E−02 | −4.1130153E−02 | 8.5133296E−03 | −1.1314430E−03 | 2.8988607E−04 |
| 10 | −1.0931820E+00 | −1.5636796E−02 | −5.4025426E−04 | 2.5447500E−03 | −2.8776753E−04 | −3.4389457E−05 | 5.4988718E−06 |
| 11 | −2.4974670E+01 | −4.0945650E−02 | 6.6799961E−03 | −2.0934738E−03 | 3.2116055E−04 | −2.4284408E−05 | 1.2173573E−06 |

TABLE 7
Example 4
f = 4.448, Bf = 0.717, TL = 4.922

| Si | Ri | Di | ndj | νdj |
|---|---|---|---|---|
| 1 (aperture stop) | ∞ | −0.479 | | |
| *2 | 1.54216 | 0.591 | 1.544 | 55.9 |
| *3 | 21474.83648 | 0.156 | | |
| *4 | −7.42046 | 0.158 | 1.63400 | 23.80 |
| *5 | 4.96580 | 0.587 | | |
| *6 | 1735.46300 | 0.258 | 1.63400 | 23.80 |
| *7 | −49.93552 | 0.721 | | |
| *8 | −7.49578 | 0.520 | 1.54400 | 55.90 |
| *9 | −1.78343 | 0.723 | | |
| *10 | −3.24703 | 0.491 | 1.53500 | 56.30 |
| *11 | 2.94349 | 0.372 | | |
| 12 | ∞ | 0.300 | 1.51700 | 64.20 |
| 13 | ∞ | 0.147 | | |
| 14 | ∞ | | | |

*aspheric surface

TABLE 8

| Surface | | | | | |
|---|---|---|---|---|---|
| No. | KA | A4 | A6 | A8 | A10 |
| 2 | −3.2524380E+00 | 1.5065096E−01 | −5.5982718E−02 | 3.8803414E−02 | −1.2157592E−02 |
| 3 | −2.4900370E+09 | 7.6435492E−03 | 1.2138084E−02 | −3.0313439E−02 | 4.4783018E−02 |
| 4 | −1.0909280E+02 | 4.4139517E−02 | 9.7437784E−03 | 3.2146520E−02 | −7.6686941E−02 |
| 5 | 1.2089540E+01 | 8.0625054E−02 | 1.4091644E−02 | 3.4953744E−02 | −4.5159215E−02 |
| 6 | −3.2350740E+21 | −1.4964513E−01 | −2.6984555E−02 | 3.0485578E−02 | −4.4023473E−02 |
| 7 | 1.0000000E+00 | −1.2220319E−01 | −1.4043378E−02 | 1.4941629E−02 | −1.2747263E−02 |
| 8 | 2.0994210E+01 | −1.3535042E−03 | 6.4694993E−03 | −3.4299536E−02 | 2.1943063E−02 |
| 9 | −4.2987300E+00 | −4.2851362E−02 | 3.6462513E−02 | −2.5926612E−02 | 4.9370368E−03 |
| 10 | −3.8512820E+00 | −1.2893548E−02 | −3.8582306E−04 | 1.6359078E−03 | −1.6309298E−04 |
| 11 | −1.1189530E+01 | −2.6471382E−02 | 5.7727919E−03 | −1.2940902E−03 | 1.7980930E−04 |
| | A12 | A14 | A16 | | |
| 2 | 3.3485257E−03 | −1.8404377E−03 | 0.0000000E+00 | | |
| 3 | −3.4176564E−02 | 9.9411196E−03 | 0.0000000E+00 | | |
| 4 | 6.5157563E−02 | −1.5315215E−02 | 0.0000000E+00 | | |
| 5 | 2.5079954E−02 | 3.1888339E−02 | 0.0000000E+00 | | |
| 6 | 3.4422885E−02 | 0.0000000E+00 | 0.0000000E+00 | | |
| 7 | 1.2040687E−02 | 0.0000000E+00 | 0.0000000E+00 | | |
| 8 | −9.9879048E−03 | 1.9077107E−03 | 0.0000000E+00 | | |
| 9 | −6.0026315E−04 | 9.5240511E−05 | 0.0000000E+00 | | |
| 10 | −1.7629494E−05 | 2.2176601E−06 | 0.0000000E+00 | | |
| 11 | −1.3117482E−05 | 3.4808324E−07 | 0.0000000E+00 | | |

TABLE 9
Example 5
f = 4.453, Bf = 0.707, TL = 4.920

| Si | Ri | Di | ndj | νdj |
|---|---|---|---|---|
| 1 (aperture stop) | ∞ | −0.479 | | |
| *2 | 1.54280 | 0.592 | 1.544 | 55.9 |
| *3 | 21474.83648 | 0.155 | | |
| *4 | −7.43748 | 0.159 | 1.63400 | 23.80 |
| *5 | 4.99290 | 0.588 | | |
| *6 | 2256.31900 | 0.256 | 1.63400 | 23.80 |
| *7 | −52.03853 | 0.730 | | |
| *8 | −7.47168 | 0.513 | 1.54400 | 55.90 |
| *9 | −1.78445 | 0.724 | | |
| *10 | −3.22136 | 0.496 | 1.53500 | 56.30 |
| *11 | 2.92139 | 0.341 | | |
| 12 | ∞ | 0.300 | 1.51700 | 64.20 |
| 13 | ∞ | 0.169 | | |
| 14 | ∞ | | | |

*aspheric surface

TABLE 10

| Surface | | | | | |
|---|---|---|---|---|---|
| No. | KA | A4 | A6 | A8 | A10 |
| 2 | −3.2638470E+00 | 1.5066095E−01 | −5.5977984E−02 | 3.8803719E−02 | −1.2157672E−02 |
| 3 | −5.9762770E+09 | 7.6419585E−03 | 1.2141008E−02 | −3.0303218E−02 | 4.4787680E−02 |
| 4 | −1.0872610E+02 | 4.4164627E−02 | 9.7373772E−03 | 3.2136889E−02 | −7.6697060E−02 |
| 5 | 1.2244360E+01 | 8.0597528E−02 | 1.4130448E−02 | 3.4988561E−02 | −4.5166430E−02 |
| 6 | −3.2415350E+21 | −1.4971704E−01 | −2.6990874E−02 | 3.0426774E−02 | −4.4074399E−02 |
| 7 | 1.0000000E+00 | −1.2224228E−01 | −1.4076476E−02 | 1.4986706E−02 | −1.2692603E−02 |
| 8 | 1.9842780E+01 | −1.3571746E−03 | 6.5127268E−03 | −3.4309265E−02 | 2.1937121E−02 |
| 9 | −4.3382240E+00 | −4.2868768E−02 | 3.6500939E−02 | −2.5927469E−02 | 4.9326137E−03 |
| 10 | −4.5224980E+00 | −1.3003011E−02 | −4.1506473E−04 | 1.6349094E−03 | −1.6317561E−04 |
| 11 | −1.1174200E+01 | −2.5588070E−02 | 5.8404713E−03 | −1.3008082E−03 | 1.7962257E−04 |
| | A12 | A14 | A16 | | |
| 2 | 3.3480104E−03 | −1.8410405E−03 | 0.0000000E+00 | | |
| 3 | −3.4181618E−02 | 9.9381618E−03 | 0.0000000E+00 | | |
| 4 | 6.5155534E−02 | −1.5304355E−02 | 0.0000000E+00 | | |
| 5 | 2.5045503E−02 | 3.1849838E−02 | 0.0000000E+00 | | |
| 6 | 3.4386194E−02 | 0.0000000E+00 | 0.0000000E+00 | | |
| 7 | 1.2077945E−02 | 0.0000000E+00 | 0.0000000E+00 | | |
| 8 | −9.9873292E−03 | 1.9093451E−03 | 0.0000000E+00 | | |
| 9 | −6.0248064E−04 | 9.4432424E−05 | 0.0000000E+00 | | |
| 10 | −1.7631948E−05 | 2.2178424E−06 | 0.0000000E+00 | | |
| 11 | −1.3107522E−05 | 3.4750991E−07 | 0.0000000E+00 | | |

TABLE 11
Example 6
f = 4.006, Bf = 0.563, TL = 4.601

| Si | Ri | Di | ndj | νdj |
|---|---|---|---|---|
| 1 (aperture stop) | ∞ | −0.370 | | |
| *2 | 1.53205 | 0.594 | 1.544 | 55.9 |
| *3 | −244.2533 | 0.161 | | |
| *4 | −7.63619 | 0.160 | 1.63400 | 23.80 |
| *5 | 5.04447 | 0.572 | | |
| *6 | 131.92940 | 0.256 | 1.63400 | 23.80 |
| *7 | −38.39986 | 0.644 | | |
| *8 | −7.97505 | 0.458 | 1.54400 | 55.90 |
| *9 | −1.77020 | 0.751 | | |
| *10 | −3.26810 | 0.442 | 1.53500 | 56.30 |
| *11 | 2.95747 | 0.228 | | |
| 12 | ∞ | 0.300 | 1.51700 | 64.20 |
| 13 | ∞ | 0.137 | | |
| 14 | ∞ | | | |

*aspheric surface

TABLE 12

| Surface | | | | | |
|---|---|---|---|---|---|
| No. | KA | A4 | A6 | A8 | A10 |
| 2 | −3.2750100E+00 | 1.5093680E−01 | −5.5896831E−02 | 3.8853577E−02 | −1.2138676E−02 |
| 3 | 1.0000000E+00 | 7.7518953E−03 | 1.2240027E−02 | −3.0268578E−02 | 4.4763164E−02 |
| 4 | −1.1147020E+02 | 4.3950916E−02 | 9.4982248E−03 | 3.2017255E−02 | −7.6662717E−02 |
| 5 | 1.2185120E+01 | 8.0628371E−02 | 1.4258265E−02 | 3.5200716E−02 | −4.4900228E−02 |
| 6 | 1.0000000E+00 | −1.4835939E−01 | −2.7138216E−02 | 3.0155911E−02 | −4.4298907E−02 |
| 7 | 1.0000000E+00 | −1.2257684E−01 | −1.3933147E−02 | 1.5063692E−02 | −1.2675846E−02 |
| 8 | 1.9880970E+01 | −2.3029630E−03 | 6.7083678E−03 | −3.4116174E−02 | 2.1964796E−02 |
| 9 | −4.4307060E+00 | −4.2646577E−02 | 3.6062420E−02 | −2.6066979E−02 | 4.9180318E−03 |
| 10 | −5.6146200E+00 | −1.1668238E−02 | −3.7319308E−04 | 1.6379329E−03 | −1.6272805E−04 |
| 11 | −8.2204650E+00 | −2.4797844E−02 | 5.8304716E−03 | −1.3054526E−03 | 1.7976597E−04 |
| | A12 | A14 | A16 | | |
| 2 | 3.3515733E−03 | −1.8191446E−03 | 1.1636071E−05 | | |
| 3 | −3.4182713E−02 | 9.9502052E−03 | 8.2276940E−06 | | |
| 4 | 6.5142837E−02 | −1.5392543E−02 | −7.1977633E−05 | | |
| 5 | 2.5266330E−02 | 3.1707511E−02 | −1.5037464E−05 | | |
| 6 | 3.4353299E−02 | −8.4908319E−05 | −4.3328445E−05 | | |
| 7 | 1.2108124E−02 | 1.7124310E−05 | 2.1742717E−05 | | |
| 8 | −9.9841170E−03 | 1.9122032E−03 | −1.9145444E−06 | | |
| 9 | −5.9906351E−04 | 9.3911565E−05 | 5.9508721E−07 | | |
| 10 | −1.7573077E−05 | 2.2139280E−06 | −8.0069936E−10 | | |
| 11 | −1.3101326E−05 | 3.4687308E−07 | −2.9514350E−11 | | |

TABLE 13

| | Condition | Example | Example | Example | Example | Example | Example |
|---|---|---|---|---|---|---|---|
| No. | Expression | 1 | 2 | 3 | 4 | 5 | 6 |
| (1) | d45/f1234 | 0.18 | 0.17 | 0.16 | 0.21 | 0.21 | 0.23 |
| (2) | d45/f | 0.13 | 0.12 | 0.12 | 0.16 | 0.16 | 0.19 |
| (3) | (R2f + R2r)/(R2f − R2r) | 0.26 | 0.12 | 0.12 | 0.20 | 0.20 | 0.20 |
| (4) | (R5f + R5r)/(R5f − R5r) | −0.33 | 0.04 | 0.00 | 0.05 | 0.05 | 0.05 |
| (5) | f · tanω/R5r | 0.64 | 1.20 | 1.09 | 1.02 | 1.03 | 0.91 |
| (6) | f/f12 | 0.84 | 0.86 | 0.86 | 0.82 | 0.82 | 0.77 |
| (7) | f/f1 | 1.73 | 1.73 | 1.72 | 1.57 | 1.57 | 1.43 |
| (8) | f/f5 | −1.56 | −1.89 | −1.76 | −1.58 | −1.60 | −1.41 |
| (9) | f/f2 | −1.20 | −1.15 | −1.14 | −0.95 | −0.95 | −0.84 |

What is claimed is:

1. An imaging lens consisting of five lenses consisting of; in order from an object side:
a first lens having a positive refractive power and having a shape with a convex surface toward the object side;
a second lens having a biconcave shape;
a third lens having a biconvex shape;
a fourth lens having a positive refractive power; and
a fifth lens having a negative refractive power, having a shape with a concave surface toward the image side, and having at least one inflection point on the image-side surface thereof,
wherein the condition expressions below are satisfied:
0.13<d45/f1234<0.3 (1), and
0.5<f·tan ω/R5r<10 (5),
where d45 is a distance between the fourth lens and the fifth lens along an optical axis, f1234 is a combined focal length of the first to the fourth lenses, f is a focal length of the entire system, ω is a half angle of view, and R5r is a radius of curvature of the image-side surface of the fifth lens.

2. The imaging lens as claimed in claim 1, wherein the condition expression below is further satisfied:
0.11<d45/f<0.3 (2),
where d45 is a distance between the fourth lens and the fifth lens along the optical axis, and f is a focal length of the entire system.

3. The imaging lens as claimed in claim 1, wherein the condition expression below is further satisfied:
0<(R2f+R2r)/(R2f−R2r)<0.5 (3),
where R2f is a paraxial radius of curvature of the object-side surface of the second lens, R2r is a paraxial radius of curvature of the image-side surface of the second lens, and |R2f|>|R2r|.

4. The imaging lens as claimed in claim 1, wherein the condition expression below is further satisfied:
−1<(R5f+R5r)/(R5f−R5r)<0.08 (4),
where R5f is a paraxial radius of curvature of the object-side surface of the fifth lens, and R5r is a paraxial radius of curvature of the image-side surface of the fifth lens.

5. The imaging lens as claimed in claim 1, wherein the condition expression below is further satisfied:
0.7<f/f12<1.2 (6),
where f is a focal length of the entire system, and f12 is a combined focal length of the first lens and the second lens.

6. The imaging lens as claimed in claim 1, wherein the condition expression below is further satisfied:
0.8<f/f1<2.5 (7),
where f is a focal length of the entire system, and f1 is a focal length of the first lens.

7. The imaging lens as claimed in claim 1, wherein the condition expression below is further satisfied:
−2.5<f/f5<−1.2 (8),
where f is a focal length of the entire system, and f5 is a focal length of the fifth lens.

8. The imaging lens as claimed in claim 1, wherein the condition expression below is further satisfied:
−2.5<f/f2<−0.7 (9),
where f is a focal length of the entire system, and f2 is a focal length of the second lens.

9. The imaging lens as claimed in claim 1, further comprising an aperture stop disposed on the object side of the object-side surface of the second lens.

10. The imaging lens as claimed in claim 1, wherein the condition expression below is further satisfied:
0.14<d45/f1234<0.25 (1-1),
where d45 is a distance between the fourth lens and the fifth lens along the optical axis, and f1234 is a combined focal length of the first to the fourth lenses.

11. The imaging lens as claimed in claim 1, wherein the condition expression below is further satisfied:
0.11<d45/f<0.25 (2-1),
where d45 is a distance between the fourth lens and the fifth lens along the optical axis, and f is a focal length of the entire system.

12. The imaging lens as claimed in claim 1, wherein the condition expression below is further satisfied:
0.1<(R2f+R2r)/(R2f−R2r)<0.35 (3-1),
where R2f is a paraxial radius of curvature of the object-side surface of the second lens, R2r is a paraxial radius of curvature of the image-side surface of the second lens, and |R2f|>|R2r|.

13. The imaging lens as claimed in claim 1, wherein the condition expression below is further satisfied:
−0.5<(R5f+R5r)/(R5f−R5r)<0.07 (4-1),
where R5f is a paraxial radius of curvature of the object-side surface of the fifth lens, and R5r is a paraxial radius of curvature of the image-side surface of the fifth lens.

14. The imaging lens as claimed in claim 1, wherein the condition expression below is further satisfied:
0.7<f·tan ω/R5r<3 (5-1),
where f is a focal length of the entire system, ω is a half angle of view, and R5r is a radius of curvature of the image-side surface of the fifth lens.

15. The imaging lens as claimed in claim 1, wherein the condition expression below is further satisfied:
0.8<f/f12<1 (6-1)
where f is a focal length of the entire system, and f12 is a combined focal length of the first lens and the second lens.

16. The imaging lens as claimed in claim 1, wherein the condition expression below is further satisfied:
1<f/f1<2 (7-1),
where f is a focal length of the entire system, and f1 is a focal length of first lens.

17. The imaging lens as claimed in claim 1, wherein the condition expression below is further satisfied:
−2<f/f5<−1.4 (8-1),
where f is a focal length of the entire system, and f5 is a focal length of the fifth lens.

18. The imaging lens as claimed in claim 1, wherein the condition expression below is further satisfied:
−1.3<f/f2<−0.8 (9-1),
where f is a focal length of the entire system, and f2 is a focal length of the second lens.

19. An imaging apparatus comprising the imaging lens as claimed in claim 1.
